(19) United States
(12) Patent Application Publication
(10) Pub. No.: US 2013/0131343 A1
(43) Pub. Date: May 23, 2013

(54) MICROWAVE-ASSISTED SYNTHESIS OF N-HETEROCYCLIC CARBENE TRANSITION METAL COMPLEXES

(71) Applicants: Oscar Navarro, Eastbourne (GB); Ole H. Winkelmann, Hamburg (DE)

(72) Inventors: Oscar Navarro, Eastbourne (GB); Ole H. Winkelmann, Hamburg (DE)

(73) Assignee: UNIVERSITY OF HAWAII, Honolulu, HI (US)

(21) Appl. No.: 13/514,573

(22) PCT Filed: Dec. 7, 2010
(86) PCT No.: PCT/US10/59232

§ 371 Date: Dec. 5, 2012

Related U.S. Application Data
(60) Provisional application No. 61/283,739, filed on Dec. 7, 2009.

(51) Int. Cl. C07F 15/00

(52) U.S. Cl. CPC C07F 15/006
USPC 546/2; 548/101

(57) ABSTRACT

Microwave heating is used to synthesize NHC-transition metal complexes. Reaction times for the formation of NHC-transition metal complexes is greatly reduced. The speed of the reactions allows for otherwise problematic air handling of reagents. Apparatus for carrying out the reactions is less complex than conventional apparatus and requires less energy to achieve the desired temperatures. Methods utilize salts of NHC's which overcomes the oftentimes difficult preparation of free carbenes for formation of the corresponding transition metal complexes.

### CROSS-REFERENCE TO RELATED APPLICATIONS

This application claims the benefit of and priority to U.S. Provisional Application Ser. No. 61/283,739 filed Dec. 7, 2009, the contents of which are incorporated herein by reference in their entirety and for all purposes.

### INTRODUCTION

1. Field

The present disclosure concerns synthesis of transition metal complexes. More specifically, the present disclosure concerns synthesis of transition metal carbene complexes using microwave radiation.

2. Background

A transition metal carbene complex is a organometallic compound featuring a divalent carbene organic ligand. Carbene complexes for almost all transition metals have been reported and many reactions utilizing them have been reported.

N-heterocyclic carbenes (NHC's) are generally derived from persistent carbenes, which are stable compounds of divalent carbon. Many NHC's have found widespread applications as ligands in organometallic chemistry during the last several years. For example, see: N-Heterocyclic Carbenes in Synthesis, 1st ed. (Ed.: S. P. Nolan), Wiley-VCH, Weinheim, 2006; and N-Heterocyclic Carbenes in Transition Metal Catalysis, 1st ed. (Ed.: F. Glorius), Springer-Verlag, Berlin, 2007.

A variety of organometallic compounds have been prepared by combining, for example, salts of NHC's with transition metal sources and heating at solvent refluxing temperatures for extended periods of time. Recent examples in the literature include, among others, compounds of nickel, silver, copper, rhodium, gold and ruthenium. For example, see: Kelly, R. A. III; Scott, N. M.; Díez-González, S.; Stevens, E. D.; Nolan, S. P. Organometallics 2005, 24, 3442-3447; Zinner, S. C.; Rentzsch, C. F.; Herdtweek, E.; Herrmann, W. A.; Kühn, F. E. Dalton Trans. 2009, 7055-7062; Chun, J.; Lee, H. S.; Jung, I. G.; Lee, S. W.; Kim, H. J.; Son, S. U. Organometallics 2010, 29, 1518-1521; Rubio, M.; Jellema, E.; Siegler, M. A.; Spek, A. L.; Reek, J. N. H.; de Bruin, B. Dalton Trans. 2009, 8970-8976; Au, V. K.-M.; Wong, K. M.-C.; Zhu, N.; Yam, W.-Y. J. Am. Chem. Soc. 2009, 131, 9076-9085; and Bruce, M. I.; Cole, M. L.; Fung, R. S. C.; Forsyth, C. M.; Hilder, M.; Junk, P. C.; Konstas, K. Dalton Trans. 2008, 4118-4128.

Problems associated with these conventional approaches include very long reaction times and air sensitivity of the reactions.

### SUMMARY

Transition metal complexes bearing NHC's are prepared by combining an NHC salt with the appropriate transition metal source, for example, a transition metal salt. The mixture is heated with microwaves to give the NHC transition metal complexes. Depending upon the desired products a base and/or a ligand might be used. Any suitable solvents may be used in the reactions, inorganic and/or organic, protic and aprotic. In particular embodiments, aprotic polar organic solvents are used. In some embodiments the ligand serves also as the solvent, for example, a pyridine can be both ligand, L, and solvent for the reaction.

One embodiment is a method of making a compound of formula I,

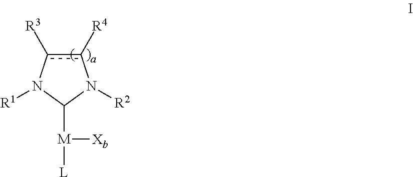

the method including:
(a) combining an N-heterocyclic carbene salt of formula II

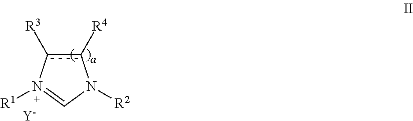

with either: i) a transition metal salt of formula MX_{b}, a ligand L and a base; or ii) a transition metal salt of formula L_{z}MX_{b}; and
(b) heating the mixture with microwave radiation;
   where:
each of R¹ and R² is independently H, C₁₋₂₀alkyl, C₃₋₂₀cycloalkyl, C₆₋₁₄aryl, C₇₋₁₆arylalkyl, 3-10 membered heteroalicyclyl, 4-11 membered heteroalicyclylalkyl, 5-15 membered heteroaryl or 6-16 membered heteroarylalkyl; each optionally substituted, and where any heteroatom of R¹ and R² is not bonded to the nitrogen which bears R¹ and R²;
R³ and R⁴ are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different IV and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
R³ and one R⁴ group, taken together with the carbons to which they are attached, combine to form a 4-10 membered partially or fully saturated mono or bicyclic ring, optionally containing one or more heteroatoms and optionally substituted with one or more R^{a} and/or R^{b}, and remaining R⁴ groups, if any, are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{c} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
one of R³ and R⁴ is a bivalent linker that links the carbon bearing the R³ or R⁴ to a solid phase; and the remaining R³ or R⁴ groups, if any, are each independently for each occurrence H, R^{c}, R^{b}, R^{c} substituted with one or more of the same or different R^{a} and/or R^{b}, —OR^{c} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b};

each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{e} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3;
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
M is a transition metal;
b is an integer representing the number of monoanionic ligands X required to fulfill the valency requirements of M;
z is an integer representing the number of neutral mono-coordinating ligands L that M can accommodate along with monoanionic ligands X; when z is greater than 1, each L may be the same or different;
X is a monoanionic ligand; when b is greater than 1, each X may be the same or different;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; or R⁵⁵CH═CHR⁶⁵ wherein R⁵⁵ and R⁶⁵ are each independently H, C₁₋₂₀ alkyl, C₃₋₂₀cycloalkyl, C₆₋₁₄aryl, C₇₋₁₆ arylalkyl, 3-10 membered heteroalicyclyl, 4-11 membered heteroalicyclylalkyl or 5-15 membered heteroaryl or 6-16 membered heteroarylalkyl; each optionally substituted; or R⁵⁵ and R⁶⁵, together with the vinyl group to which they are attached, combine to form a 4 to 8 membered cycloalkyldiene;
in one or more instances, one of X can combine with one of L to form a bidentate monoanionic ligand, where said one of X is the anionic portion of the bidentate monoanionic ligand and L is the neutral coordination portion of the bidentate monoanionic ligand; and
Y is a suitable monoanion.
   Another embodiment is method of making a compound of formula I,

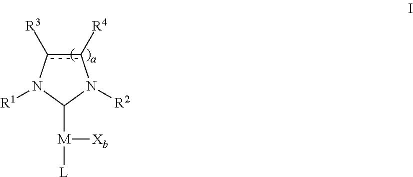

the method including:
(a) combining an N-heterocyclic carbene salt of formula II

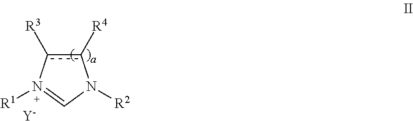

with a transition metal salt of formula MX_{b}, a ligand L and a base; and
(b) heating the mixture with microwave radiation;
   wherein:
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or

R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkyl alkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3; and
each n is 0, 1, 2 or 3.
M is Pd, Pt, Ni, Cu, Au, Ag, Ru, Rh or Ir;
b is an integer representing the number of monoanionic ligands X required to fulfill the valency requirements of M;
X is a monoanionic ligand;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; and
Y is a suitable anion.
   Another embodiment is a method of making a compound of formula V,

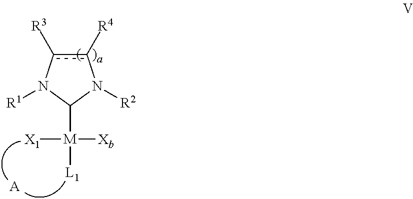

the method including:
(a) combining an N-heterocyclic carbene salt of formula II

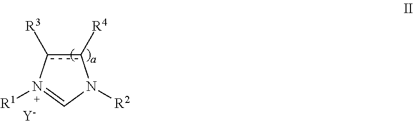

with a transition metal salt of formula VI; and

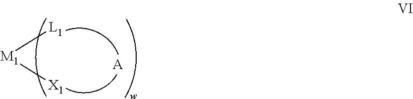

(b) heating the mixture with microwave radiation;
   wherein:
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{e})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₙ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3;
M₁ is Pd, Pt, Ni, Cu, Au, Ag, Ru, Rh or Tr; when M₁ is Ag, then w is 1; when M₁ is Pd, Pt, Ni or Cu, then w is 2; when M₁ is Ir, Au, Rh or Ru, then w is 3;
b is an integer representing the number of monoanionic ligands X required to fulfill the valency requirements of M;
X is a monoanionic ligand;
Y is a suitable anion; and
X₁-A-L₁ is according to formula IV:

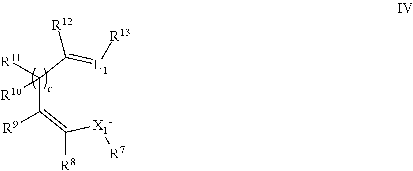

wherein each of X₁ and L₁ is independently O or N; R⁷, R⁸, R⁹, R¹⁰, R¹¹, R¹² and R¹³ are each independently H, C₁₋₆alkyl, C₃₋₈ cycloalkyl, C₄₋₁₁ cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl, each optionally substituted; provided R⁷ and R¹³ are present only when X₁ and/or L₁ are N; c is 0, 1 or 2; and the compound of formula I includes one of the bidentate monoanionic ligand X₁-A-L₁ and one monoanionic ligand X.

More detailed description for these and other embodiments is provided below.

### DETAILED DESCRIPTION

The inventors have found that by using microwave heating, reaction times for the preparation of NHC-transition metal complexes is greatly reduced. In some embodiments, the speed of the reactions allows for otherwise problematic air handling of the reagents. Also, since the reactions can be performed in a sealed tube, apparatus for carrying out the reactions is less complex than conventional apparatus, for example, glassware for reflux which includes cooling jackets, inert atmosphere, heating coils and the like. The reactions utilize salts of NHC's which overcomes the oftentimes difficult preparation of free carbenes for formation of the corresponding transition metal complex. Reagent stoichiometries, particular solvents, bases and other parameters are described in more detail below.

### Terms

As used herein, the following words and phrases are intended to have the meanings as set forth below, except to the extent that the context in which they are used indicates otherwise or they are expressly defined to mean something different.

The symbol “—” means a single bond, “═” means a double bond, “≡” means a triple bond. The symbol “ [symbol] ” means either a single or a double bond. The symbol “ [symbol] ” refers to a group on a double-bond as occupying either position on the terminus of the double bond to which the symbol is attached; that is, the geometry, E- or Z—, of the double bond is ambiguous and both isomers are meant to be included. When a group is depicted removed from its parent formula, the “ [symbol] ” symbol will be used at the end of the bond which was theoretically cleaved in order to separate the group from its parent structural formula.

When chemical structures are depicted or described, unless explicitly stated otherwise, all carbons are assumed to have hydrogen substitution to conform to a valence of four. For example, in the structure on the left-hand side of the schematic below there are nine hydrogens implied. The nine hydrogens are depicted in the right-hand structure. Sometimes a particular atom in a structure is described in textual formula as having a hydrogen or hydrogens as substitution (expressly defined hydrogen), for example, —CH₂CH₂—. It would be understood by one of ordinary skill in the art that the aforementioned descriptive techniques are common in the chemical arts to provide brevity and simplicity to description of otherwise complex structures.

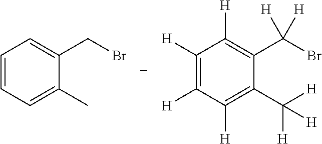

In this application, some ring structures are depicted generically and will be described textually. For example, in the schematic below if ring A is used to describe a phenyl, there are at most four hydrogens on ring A (when R is not H).

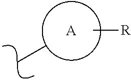

If a group R is depicted as “floating” on a ring system, as for example in the group:

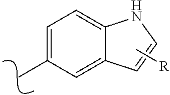

then, unless otherwise defined, a substituent R can reside on any atom of the fused bicyclic ring system, excluding the atom carrying the bond with the “ [symbol] ” symbol, so long as a stable structure is formed. In the example depicted, the R group can reside on an atom in either the 5-membered or the 6-membered ring of the indolyl ring system.

When there are more than one such depicted “floating” groups, as for example in the formulae:

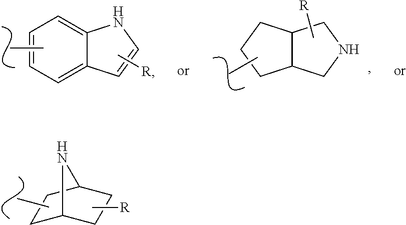

where there are two groups, namely, the R and the bond indicating attachment to a parent structure; then, unless otherwise defined, the “floating” groups can reside on any atoms of the ring system, again assuming each replaces a depicted, implied, or expressly defined hydrogen on the ring system and a chemically stable compound would be formed by such an arrangement.

When a group R is depicted as existing on a ring system containing saturated carbons, as for example in the formula:

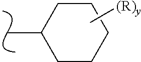

where, in this example, y can be more than one, assuming each replaces a currently depicted, implied, or expressly defined hydrogen on the ring; then, unless otherwise defined, two R's can reside on the same carbon. A simple example is when R is a methyl group; there can exist a geminal dimethyl on a carbon of the depicted ring (an “annular” carbon). In another example, two R's on the same carbon, including that same carbon, can form a ring, thus creating a spirocyclic ring (a “spirocyclyl” group) structure. Using the previous example, where two R's form, e.g. a piperidine ring in a spirocyclic arrangement with the cyclohexane, as for example in the formula:

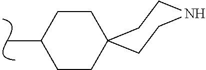

“Alkyl” in its broadest sense is intended to include linear, branched, or cyclic hydrocarbon structures, and combinations thereof. Alkyl groups can be fully saturated or with one or more units of unsaturation, but not aromatic. Generally alkyl groups are defined by a subscript, either a fixed integer or a range of integers. For example, “C₈alkyl” includes n-octyl, iso-octyl, 3-octynyl, cyclohexenylethyl, cyclohexylethyl, and the like; where the subscript “8” designates that all groups defined by this term have a fixed carbon number of eight. In another example, the term “C₁₋₆alkyl” refers to alkyl groups having from one to six carbon atoms and, depending on any unsaturation, branches and/or rings, the requisite number of hydrogens. Examples of C₁₋₆alkyl groups include methyl, ethyl, vinyl, propyl, isopropyl, butyl, s-butyl, t-butyl, isobutyl, isobutenyl, pentyl, pentynyl, hexyl, cyclohexyl, hexenyl, and the like. When an alkyl residue having a specific number of carbons is named generically, all geometric isomers having that number of carbons are intended to be encompassed. For example, either “propyl” or “C₃alkyl” each include n-propyl, c-propyl, propenyl, propynyl, and isopropyl. Cycloalkyl is a subset of alkyl and includes cyclic hydrocarbon groups of from three to thirteen carbon atoms. Examples of cycloalkyl groups include c-propyl, c-butyl, c-pentyl, norbornyl, norbornenyl, c-hexenyl, adamantyl and the like. As mentioned, alkyl refers to alkanyl, alkenyl, and alkynyl residues (and combinations thereof)—it is intended to include, e.g., cyclohexylmethyl, vinyl, allyl, isoprenyl, and the like. An alkyl with a particular number of carbons can be named using a more specific but still generic geometrical constraint, e.g. “C₃₋₆cycloalkyl” which means only cycloalkyls having between 3 and 6 carbons are meant to be included in that particular definition. Unless specified otherwise, alkyl groups, whether alone or part of another group, e.g. —C(O)alkyl, have from one to twenty carbons, that is C₁₋₂₀alkyl. In the example “—C(O)alkyl,” where there were no carbon count limitations defined, the carbonyl of the —C(O)alkyl group is not included in the carbon count, since “alkyl” is designated generically. But where a specific carbon limitation is given, e.g. in the term “optionally substituted C₁₋₂₀alkyl,” where the optional substitution includes “oxo” the carbon of any carbonyls formed by such “oxo” substitution are included in the carbon count since they were part of the original carbon count limitation. However, again referring to “optionally substituted C₁₋₂₀alkyl,” if optional substitution includes carbon-containing groups, e.g. —CH₂CO₂H, the two carbons in this group are not included in the C₁₋₂₀alkyl carbon limitation.

When a carbon number limit is given at the beginning of a term which itself includes two terms, the carbon number limitation is understood as inclusive for both terms. For example, for the term “C₇₋₁₄arylalkyl,” both the “aryl” and the “alkyl” portions of the term are included the carbon count, a maximum of 14 in this example, but additional substituent groups thereon are not included in the atom count unless they incorporate a carbon from the group's designated carbon count, as in the “oxo” example above. Likewise when an atom number limit is given, for example “6-14 membered heteroarylalkyl,” both the “heteroaryl” and the “alkyl” portion are included the atom count limitation, but additional substituent groups thereon are not included in the atom count unless they incorporate a carbon from the group's designated carbon count. In another example, “C₄₋₁₀cycloalkylalkyl” means a cycloalkyl bonded to the parent structure via an alkylene, alkylidene or alkylidyne; in this example the group is limited to 10 carbons inclusive of the alkylene, alkylidene or alkylidyne subunit. As another example, the “alkyl” portion of, e.g. “C₇₋₁₄arylalkyl” is meant to include alkylene, alkylidene or alkylidyne, unless stated otherwise, e.g. as in the terms “C₇₋₁₄arylalkylene” or “C₆₋₁₀aryl-CH₂CH₂—.”

“Alkylene” refers to straight, branched and cyclic (and combinations thereof) divalent radical consisting solely of carbon and hydrogen atoms, containing no unsaturation and having from one to ten carbon atoms, for example, methylene, ethylene, propylene, n-butylene and the like. Alkylene is like alkyl, referring to the same residues as alkyl, but having two points of attachment and, specifically, fully saturated. Examples of alkylene include ethylene (—CH₂CH₂—), propylene (—CH₂CH₂CH₂—), dimethylpropylene (—CH₂C(CH₃)₂CH₂—), cyclohexan-1,4-diyl and the like.

“Alkylidene” refers to straight, branched and cyclic (and combinations thereof) unsaturated divalent radical consisting solely of carbon and hydrogen atoms, having from two to ten carbon atoms, for example, ethylidene, propylidene, n-butylidene, and the like. Alkylidene is like alkyl, referring to the same residues as alkyl, but having two points of attachment and, specifically, at least one unit of double bond unsaturation. Examples of alkylidene include vinylidene (—CH═CH—), cyclohexylvinylidene (—CH═C(C₆H₁₃)—), cyclohexen-1,4-diyl and the like.

“Alkylidyne” refers to straight, branched and cyclic (and combinations thereof) unsaturated divalent radical consisting solely of carbon and hydrogen atoms having from two to ten carbon atoms, for example, propylid-2-ynyl, n-butylid-1-ynyl, and the like. Alkylidyne is like alkyl, referring to the same residues as alkyl, but having two points of attachment and, specifically, at least one unit of triple bond unsaturation.

Any of the above radicals” “alkylene,” “alkylidene” and “alkylidyne,” when optionally substituted, can contain alkyl substitution which itself can contain unsaturation. For example, 2-(2-phenylethynyl-but-3-enyl)-naphthalene (IUPAC name) contains an n-butylid-3-ynyl radical with a vinyl substituent at the 2-position of the radical. Combinations of alkyls and carbon-containing substitutions thereon are limited to thirty carbon atoms.

“Alkoxy” refers to the group —O-alkyl, where alkyl is as defined herein. Alkoxy includes, by way of example, methoxy, ethoxy, n-propoxy, isopropoxy, n-butoxy, t-butoxy, sec-butoxy, n-pentoxy, cyclohexyloxy, cyclohexenyloxy, cyclopropylmethyloxy, and the like.

“Haloalkyloxy” refers to the group —O-alkyl, where alkyl is as defined herein, and further, alkyl is substituted with one or more halogens. By way of example, a haloC₁₋₃alkyloxy″ group includes —OCF₃, —OCF₂H, —OCHF₂, —OCH₂CH₂Br, —OCH₂CH₂CH₂I, —OC(CH₃)₂Br, —OCH₂Cl and the like.

“Acyl” refers to the groups —C(O)H, —C(O)alkyl, —C(O)aryl and —C(O)heterocyclyl.

“α-Amino Acids” refer to naturally occurring and commercially available α-amino acids and optical isomers thereof. Typical natural and commercially available α-amino acids are glycine, alanine, serine, homoserine, threonine, valine, norvaline, leucine, isoleucine, norleucine, aspartic acid, glutamic acid, lysine, ornithine, histidine, arginine, cysteine, homocysteine, methionine, phenylalanine, homophenylalanine, phenylglycine, ortho-tyrosine, meta-tyrosine, para-tyrosine, tryptophan, glutamine, asparagine, proline and hydroxyproline. A “side chain of an α-amino acid” refers to the radical found on the α-carbon of an α-amino acid as defined above, for example, hydrogen (for glycine), methyl (for alanine), benzyl (for phenylalanine), etc.

“Amino” refers to the group —NH₂.

“Amide” refers to the group —C(O)NH₂ or —N(H)acyl.

“Aryl” (sometimes referred to as “Ar”) refers to a monovalent aromatic carbocyclic group of, unless specified otherwise, from 6 to 15 carbon atoms having a single ring (e.g., phenyl) or multiple condensed rings (e.g., naphthyl or anthryl) which condensed rings may or may not be aromatic (e.g., 2-benzoxazolinone, 2H-1,4-benzoxazin-3(4H)-one-7-yl, 9,10-dihydrophenanthrenyl, indanyl, tetralinyl, and fluorenyl and the like), provided that the point of attachment is through an atom of an aromatic portion of the aryl group and the aromatic portion at the point of attachment contains only carbons in the aromatic ring. If any aromatic ring portion contains a heteroatom, the group is a heteroaryl and not an aryl. Aryl groups are monocyclic, bicyclic, tricyclic or tetracyclic.

“Arylene” refers to an aryl that has at least two groups attached thereto. For a more specific example, “phenylene” refers to a divalent phenyl ring radical. A phenylene, thus can have more than two groups attached, but is defined by a minimum of two non-hydrogen groups attached thereto.

“Arylalkyl” refers to a residue in which an aryl moiety is attached to a parent structure via one of an alkylene, alkylidene, or alkylidyne radical. Examples include benzyl, phenethyl, phenylvinyl, phenylallyl and the like. When specified as “optionally substituted,” both the aryl, and the corresponding alkylene, alkylidene, or alkylidyne portion of an arylalkyl group can be optionally substituted. By way of example, “C₇₋₁₁arylalkyl” refers to an arylalkyl limited to a total of eleven carbons, e.g., a phenylethyl, a phenylvinyl, a phenylpentyl and a naphthylmethyl are all examples of a “C₇₋₁₁arylalkyl” group.

“Aryloxy” refers to the group —O-aryl, where aryl is as defined herein, including, by way of example, phenoxy, naphthoxy, and the like.

“Carboxyl,” “carboxy” or “carboxylate” refers to —CO₂H or salts thereof.

“Carboxyl ester” or “carboxy ester” or “ester” refers to the group —CO₂alkyl, —CO₂aryl or —CO₂heterocyclyl.

“Carbonate” refers to the group —OCO₂alkyl, —OCO₂aryl or —OCO₂heterocyclyl.

“Carbamate” refers to the group —OC(O)NH₂, —N(H)carboxyl or —N(H)carboxyl ester.

“Cyano” or “nitrile” refers to the group —CN.

“Formyl” refers to the specific acyl group —C(O)H.

“Halo” or “halogen” refers to fluoro, chloro, bromo and iodo.

“Haloalkyl” and “haloaryl” refer generically to alkyl and aryl radicals that are substituted with one or more halogens, respectively. By way of example “dihaloaryl,” “dihaloalkyl,” “trihaloaryl” etc. refer to aryl and alkyl substituted with a plurality of halogens, but not necessarily a plurality of the same halogen; thus 4-chloro-3-fluorophenyl is a dihaloaryl group.

“Heteroalkyl” refers to an alkyl where one or more, but not all, carbons are replaced with a heteroatom. A heteroalkyl group has either linear or branched geometry. By way of example, a “2-6 membered heteroalkyl” is a group that can contain no more than 5 carbon atoms, because at least one of the maximum 6 atoms must be a heteroatom, and the group is linear or branched. Also, for the purposes of this invention, a heteroalkyl group always starts with a carbon atom, that is, although a heteroalkyl may contain one or more heteroatoms, the point of attachment to the parent molecule is not a heteroatom. A 2-6 membered heteroalkyl group includes, for example, —CH₂XCH₃, —CH₂CH₂XCH₃, —CH₂CH₂XCH₂CH₃, —C(CH₂)₂XCH₂CH₃ and the like, where X is O, NH, NC₁₋₆alkyl and S(O)₀₋₂, for example.

“Perhalo” as a modifier means that the group so modified has all its available hydrogens replaced with halogens. An example would be “perhaloalkyl.” Perhaloalkyls include —CF₃, —CF₂CF₃, perchloroethyl and the like.

“Hydroxy” or “hydroxyl” refers to the group —OH.

“Heteroatom” refers to O, S, N, or P.

“Heterocyclyl” in the broadest sense includes aromatic and non-aromatic ring systems and more specifically refers to a stable three- to fifteen-membered ring radical that consists of carbon atoms and from one to five heteroatoms. For purposes of this invention, the heterocyclyl radical can be a monocyclic, bicyclic or tricyclic ring system, which can include fused or bridged ring systems as well as spirocyclic systems; and the nitrogen, phosphorus, carbon or sulfur atoms in the heterocyclyl radical can be optionally oxidized to various oxidation states. In a specific example, the group —S(O)₀₋₂—, refers to —S— (sulfide), —S(O)— (sulfoxide), and —SO₂— (sulfone) linkages. For convenience, nitrogens, particularly but not exclusively, those defined as annular aromatic nitrogens, are meant to include their corresponding N-oxide form, although not explicitly defined as such in a particular example. Thus, for a compound having, for example, a pyridyl ring; the corresponding pyridyl-N-oxide is meant to be included in the presently disclosed compounds. In addition, annular nitrogen atoms can be optionally quaternized. “Heterocycle” includes heteroaryl and heteroalicyclyl, that is a heterocyclic ring can be partially or fully saturated or aromatic. Thus a term such as “heterocyclylalkyl” includes heteroalicyclylalkyls and heteroarylalkyls. Examples of heterocyclyl radicals include, but are not limited to, azetidinyl, acridinyl, benzodioxolyl, benzodioxanyl, benzofuranyl, carbazoyl, cinnolinyl, dioxolanyl, indolizinyl, naphthyridinyl, perhydroazepinyl, phenazinyl, phenothiazinyl, phenoxazinyl, phthalazinyl, pteridinyl, purinyl, quinazolinyl, quinoxalinyl, quinolinyl, isoquinolinyl, tetrazoyl, tetrahydroisoquinolyl, piperidinyl, piperazinyl, 2-oxopiperazinyl, 2-oxopiperidinyl, 2-oxopyrrolidinyl, 2-oxoazepinyl, azepinyl, pyrrolyl, 4-piperidonyl, pyrrolidinyl, pyrazolyl, pyrazolidinyl, imidazolyl, imidazolinyl, imidazolidinyl, dihydropyridinyl, tetrahydropyridinyl, pyridinyl, pyrazinyl, pyrimidinyl, pyridazinyl, oxazolyl, oxazolinyl, oxazolidinyl, triazolyl, isoxazolyl, isoxazolidinyl, morpholinyl, thiazolyl, thiazolinyl, thiazolidinyl, isothiazolyl, quinuclidinyl, isothiazolidinyl, indolyl, isoindolyl, indolinyl, isoindolinyl, octahydroindolyl, octahydroisoindolyl, quinolyl, isoquinolyl, decahydroisoquinolyl, benzimidazolyl, thiadiazolyl, benzopyranyl, benzothiazolyl, benzoxazolyl, furyl, diazabicycloheptane, diazapane, diazepine, tetrahydrofuryl, tetrahydropyranyl, thienyl, benzothieliyl, thiamorpholinyl, thiamorpholinyl sulfoxide, thiamorpholinyl sulfone, dioxaphospholanyl, and oxadiazolyl.

“Heteroaryl” refers to an aromatic group having from 1 to 10 annular carbon atoms and 1 to 4 annular heteroatoms, that is, up to 14 ring atoms including up to 4 heteroatoms. Heteroaryl groups have at least one aromatic ring component, but heteroaryls can be fully unsaturated or partially unsaturated. If any aromatic ring in the group has a heteroatom, then the group is a heteroaryl, even, for example, if other aromatic rings in the group have no heteroatoms. For example, 2H-pyrido[3,2-b][1,4]oxazin-3(4H)-one-7-yl, indolyl and benzimidazolyl are “heteroaryls.” Heteroaryl groups can have a single ring (e.g., pyridinyl, imidazolyl or furyl) or multiple condensed rings (e.g., indolizinyl, quinolinyl, benzimidazolyl or benzothienyl), where the condensed rings may or may not be aromatic and/or contain a heteroatom, provided that the point of attachment to the parent molecule is through an atom of the aromatic portion of the heteroaryl group. In one embodiment, the nitrogen and/or sulfur ring atom(s) of the heteroaryl group are optionally oxidized to provide for the N-oxide (N→O), sulfinyl, or sulfonyl moieties. Compounds described herein containing phosphorous, in a heterocyclic ring or not, include the oxidized forms of phosphorous. Heteroaryl groups are monocyclic, bicyclic, tricyclic or tetracyclic.

“Heteroaryloxy” refers to —O-heteroaryl.

“Heteroarylene” generically refers to any heteroaryl that has at least two groups attached thereto. For a more specific example, “pyridylene” refers to a divalent pyridyl ring radical. A pyridylene, thus can have more than two groups attached, but is defined by a minimum of two non-hydrogen groups attached thereto.

“Heteroalicyclic” refers specifically to a non-aromatic heterocyclyl radical. A heteroalicyclic may contain unsaturation, but is not aromatic. As mentioned, aryls and heteroaryls are attached to the parent structure via an aromatic ring. So, e.g., 2,3-dihydrobenzo[b][1,4]dioxin-6-yl is an aryl, while 2,3-dihydrobenzo[b][1,4]dioxin-2-yl is a heteroalicyclic.

“Heterocyclylalkyl” refers to a heterocyclyl group linked to the parent structure via e.g an alkylene linker, for example (tetrahydrofuran-3-yl)methyl- or (pyridin-4-yl)methyl

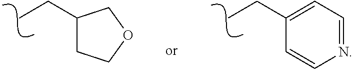

“Heterocyclyloxy” refers to the group —O-heterocycyl.

“Nitro” refers to the group —NO₂.

“Oxo” refers to a double bond oxygen radical, ═O.

“Oxy” refers to —O. radical (also designated as →O), that is, a single bond oxygen radical. By way of example, N-oxides are nitrogens bearing an oxy radical.

When a group with its bonding structure is denoted as being bonded to two partners; that is, a divalent radical, for example, —OCH₂—, then it is understood that either of the two partners can be bound to the particular group at one end, and the other partner is necessarily bound to the other end of the divalent group, unless stated explicitly otherwise. Stated another way, divalent radicals are not to be construed as limited to the depicted orientation, for example “—OCH₂-” is meant to mean not only “—OCH₂—” as drawn, but also “—CH₂O—.”

“Optional” or “optionally” means that the subsequently described event or circumstance may or may not occur, and that the description includes instances where said event or circumstance occurs and instances in which it does not. One of ordinary skill in the art would understand that, with respect to any molecule described as containing one or more optional substituents, that only synthetically feasible compounds are meant to be included. “Optionally substituted” refers to all subsequent modifiers in a term, for example in the term “optionally substituted arylC₁₋₈alkyl,” optional substitution may occur on both the “C₁₋₈alkyl” portion and the “aryl” portion of the arylC₁₋₈alkyl group. Also by way of example, optionally substituted alkyl includes optionally substituted cycloalkyl groups. The term “substituted,” when used to modify a specified group or radical, means that one or more hydrogen atoms of the specified group or radical are each, independently of one another, replaced with the same or different substituent groups as defined below. Thus, when a group is defined as “optionally substituted” the definition is meant to encompass when the group is substituted with one or more of the substituent groups defined below, and when it is not so substituted.

Substituent groups for substituting for one or more hydrogens (any two hydrogens on a single carbon can be replaced with ═O, ═NR⁷⁰, ═N—OR⁷⁰, ═N₂ or ═S) on saturated carbon atoms in the specified group or radical are, unless otherwise specified, —R⁶⁰, halo, ═O, —OR⁷⁰, —SR⁷⁰, —N(R⁸⁰⁾₂, perhaloalkyl, —CN, —OCN, —SCN, —NO, —NO₂, ═N₂, —N₃, —SO₂R⁷⁰, —SO₃⁻M⁺, —SO₃R⁷⁰, —OSO₂R⁷⁰, —OSO₃⁻M⁺, —OSO₃R⁷⁰, —P(O)(O⁻)₂(M⁺)₂, —P(O)(O⁻)₂M²⁺, —P(O)(OR⁷⁰)O⁻M⁺, —P(O)(OR⁷⁰)₂, —C(O)R⁷⁰, —C(S)R⁷⁰, —C(NR⁷⁰)R⁷⁰, —CO₂⁻M⁺, —CO₂R⁷⁰, —C(S)OR⁷⁰, —C(O)N(R⁸⁰)₂, —C(NR⁷⁰)(R⁸⁰)₂, —OC(O)R⁷⁰, —OC(S)R⁷⁰, —OCO₂⁻M⁺, —OCO₂R⁷⁰, —OC(S)OR⁷⁰, —NR⁷⁰C(O)R⁷⁰, —NR⁷⁰C(S)R⁷⁰, —NR⁷⁰CO₂⁻M⁺, —NR⁷⁰CO₂R⁷⁰, —NR⁷⁰C(S)OR⁷⁰, —NR⁷⁰C(O)N(R⁸⁰)₂, —NR⁷⁰C(NR⁷⁰)R⁷⁰ and —NR⁷⁰C(NR⁷⁰)N(R⁸⁰)₂, where R⁶⁰ is C₁₋₆alkyl, 3 to 10-membered heterocyclyl, 3 to 10-memberedheterocyclylC₁₋₆alkyl, C₆₋₁₀aryl or C₆₋₁₀arylC₁₋₆alkyl; each R⁷⁰ is independently for each occurence hydrogen or R⁶⁰; each R⁸⁰ is independently for each occurence R⁷⁰ or alternatively, two R⁸⁰'s, taken together with the nitrogen atom to which they are bonded, form a 3 to 7-membered heteroalicyclyl which optionally includes from 1 to 4 of the same or different additional heteroatoms selected from O, N and S, of which N optionally has H or C₁-C₃alkyl substitution; and each M⁺ is a counter ion with a net single positive charge. Each M⁺ is independently for each occurence, for example, an alkali ion, such as K⁺, Na⁺, Li⁺; an ammonium ion, such as ⁺N(R⁶⁰)₄; or an alkaline earth ion, such as [Ca²⁺]_{0.5}, [Mg²⁺]_{0.5}, or [Ba²⁺]_{0.5} (a “subscript 0.5 means e.g. that one of the counter ions for such divalent alkali earth ions can be an ionized form of a compound of the invention and the other a typical counter ion such as chloride, or two ionized compounds can serve as counter ions for such divalent alkali earth ions, or a doubly ionized compound can serve as the counter ion for such divalent alkali earth ions). As a specific example of one of the above enumerated groups, —N(R⁸⁰)₂, is meant to include, for example, —NH₂, —NH-alkyl, —NH-pyrrolidin-3-yl, N-pyrrolidinyl, N-piperazinyl, 4N-methyl-piperazin-1-yl, N-morpholinyl and the like.

Substituent groups for replacing hydrogens on unsaturated carbon atoms in groups containing unsaturated carbons are, unless otherwise specified, —R⁶⁰, halo, —O⁻M⁺, —OR⁷⁰, —SR⁷⁰, —S⁻M⁺, —N(R⁸⁰)₂, perhaloalkyl, —CN, —OCN, —SCN, —NO, —NO₂, —N₃, —SO₂R⁷⁰, —SO₃⁻M⁺, —SO₃R⁷⁰, —OSO₂R⁷⁰, —OSO₃ M⁺, —OSO₃R⁷⁰, —PO₃⁻²(M⁺)₂, —PO₃⁻²M²⁺, —P(O)(OR⁷⁰)O M⁺, —P(O)(OR⁷⁰)₂, —C(O)R⁷⁰, —C(S)R⁷⁰, —C(NR⁷⁰)R⁷⁰, —CO₂⁻M⁺, —CO₂R⁷⁰, —C(S)OR⁷⁰, —C(O)NR⁸⁰R⁸⁰, —C(NR⁷⁰)N(R⁸⁰)₂, —OC(O)R⁷⁰, —OC(S)R⁷⁰, —OCO₂⁻M⁺, —OCO₂R⁷⁰, —OC(S)OR⁷⁰, —NR⁷⁰C(O)R⁷⁰, —NR⁷⁰C(S)R⁷⁰, —NR⁷⁰CO₂⁻M⁺, —NR⁷⁰CO₁R⁷⁰, —NR⁷⁰C(S)OR⁷⁰, —NR⁷⁰C(O)N(R⁸⁰)₂, —NR⁷⁰C(NR⁷⁰)R⁷⁰ and —NR⁷⁰C(NR⁷⁰)N(R⁸⁰)₂, where R⁶⁰, R⁷⁰, R⁸⁰ and M⁺ are as previously defined, provided that in case of substituted alkene or alkyne, the substituents are not —O⁻M⁺, —OR⁷⁰, —SR⁷⁰, or —S⁻M⁺.

Substituent groups for replacing hydrogens on nitrogen atoms in groups containing such nitrogen atoms are, unless otherwise specified, —R⁶⁰, —O⁻M⁺, —OR⁷⁰, —SR⁷⁰, —S⁻M⁺, —N(R⁸⁰)₂, perhaloalkyl, —CN, —NO, —NO₂, —S(O)₂R⁷⁰, —SO₃⁻M⁺, —SO₃R⁷⁰, —OS(O)₂R⁷⁰, —OSO₃⁻M⁺, —OSO₃R⁷⁰, —PO₃²⁻(M⁺)₂, —PO₃²⁻M²⁺, —P(O)(OR⁷⁰)O⁻M⁺, —P(O)(OR⁷⁰)(OR⁷⁰), —C(O)R⁷⁰, —C(S)R⁷⁰, —C(NR⁷⁰)R⁷⁰, —CO₂R⁷⁰, —C(S)OR⁷⁰, —C(O)NR⁸⁰R⁸⁰, —C(NR⁷⁰)NR⁸⁰R⁸⁰, —OC(O)R⁷⁰, —OC(S)R⁷⁰, —OCO₂R⁷⁰, —OC(S)OR⁷⁰, —NR⁷⁰C(O)R⁷⁰, —NR⁷⁰C(S)R⁷⁰, —NR⁷⁰CO₂R⁷⁰, —NR⁷⁰C(S)OR⁷⁰, —NR⁷⁰C(O)N(R⁸⁰)₂, —NR⁷⁰C(NR⁷⁰)R⁷⁰ and —NR⁷⁰C(NR⁷⁰)N(R⁸⁰)₂, where R⁶⁰, R⁷⁰, R⁸⁰ and M⁺ are as previously defined.

In one embodiment, a group that is substituted has 1, 2, 3, or 4 substituents, 1, 2, or 3 substituents, 1 or 2 substituents, or 1 substituent.

It is understood that in all substituted groups, polymers arrived at by defining substituents with further substituents to themselves (e.g., substituted aryl having a substituted aryl group as a substituent which is itself substituted with a substituted aryl group, which is further substituted by a substituted aryl group, etc.) are not intended for inclusion herein. In such case that the language permits such multiple substitutions, the maximum number of such iterations of substitution is three.

“Sulfonamide” refers to the group —SO₂NH₂, —N(H)SO₂H, —N(H)SO₂alkyl, —N(H)SO₂aryl, or —N(H)SO₂heterocyclyl.

“Sulfonyl” refers to the group —SO₂H, —SO₂alkyl, —SO₂aryl, or —SO₂heterocyclyl.

“Sulfanyl” refers to the group: —SH, —S-alkyl, —S-aryl, or —S-heterocyclyl.

“Sulfonyl” refers to the group: —S(O)H, —S(O)alkyl, —S(O)aryl or —S(O)heterocyclyl.

“Bivalent Linker” In certain embodiments of the invention, the NHC salt and/or the product NHC-transition metal compex is covalently tethered to a solid support, such as a polymer bead or a resin. A bivalent linker is meant to mean a suitable linker for linking the NHC (via R³ or R⁴) to a polymer bead or resin. For example, the carbene-containing ligand of a compound described herein may be covalently tethered to a solid support, such as a Wang resin. In certain embodiments, the NHC salt and/or the product NHC-transition metal complex may be anchored or supported on a catalyst support, including a refractory oxide, such as silica, alumina, titania, or magnesia; or an aluminosilicate clay, or molecular sieve or zeolite, or an organic polymeric resin or sol gel derived monolithic glass. Compounds described herein may be used in applications for solid-phase synthesis in which multi-step reactions can be performed on resins in continuous flow or batch manner. Those of ordinary skill in the art of organic synthesis will readily identify suitable bivalent linking groups. Examples include, for example, any of the above radicals “alkylene,” “alkylidene” and “alkylidyne,” each can be optionally substituted. Such bivalent linkers may optionally include functionality to cleave the linker and release the complex.

In certian embodiments, the symbol “ [symbol] ” is used to designate is a single or a double bond in, for example, formula I. Further, the variable “a” is defined as, for example, 1, 2 or 3; when a is 3, either there is a single or a double bond between the second and third carbons bearing R⁴, or [symbol] is a single bond and there is a double bond between the first and second carbons bearing R⁴. These alternatives, when a is 3, are illustrated below.

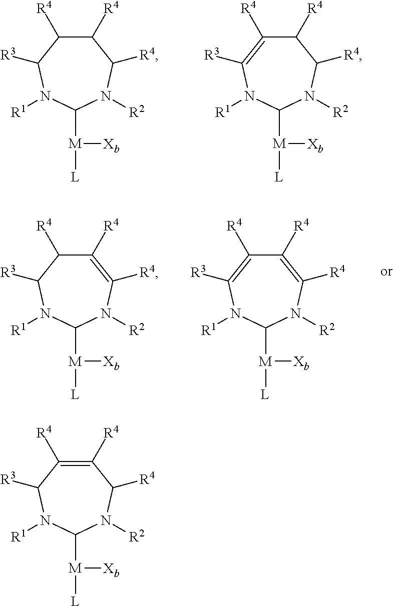

“Stereoisomer” and “stereoisomers” refer to compounds that have the same atomic connectivity but different atomic arrangement in space. Stereoisomers include cis-trans isomers, E and Z isomers, enantiomers and diastereomers. Compounds of the invention can contain one or more asymmetric centers and can thus give rise to enantiomers, diastereomers, and other stereoisomeric forms that can be defined, in terms of absolute stereochemistry, as (R)— or (S)— or, as (D)- or (L)- for amino acids. The present invention is meant to include all such possible isomers, as well as their racemic and optically pure forms. Optically active (+) and (−), (R)- and (S)-, or (D)- and (L)-isomers can be prepared using chiral synthons, chiral reagents, or resolved using conventional techniques, such as by: formation of diastereoisomeric salts or complexes which can be separated, for example, by crystallization; via formation of diastereoisomeric derivatives which can be separated, for example, by crystallization, selective reaction of one enantiomer with an enantiomer-specific reagent, for example enzymatic oxidation or reduction, followed by separation of the modified and unmodified enantiomers; or gas-liquid or liquid chromatography in a chiral environment, for example on a chiral support, such as silica with a bound chiral ligand or in the presence of a chiral solvent. It will be appreciated that where a desired enantiomer is converted into another chemical entity by one of the separation procedures described above, a further step may be required to liberate the desired enantiomeric form. Alternatively, specific enantiomer can be synthesized by asymmetric synthesis using optically active reagents, substrates, catalysts or solvents, or by converting on enantiomer to the other by asymmetric transformation. For a mixture of enantiomers, enriched in a particular enantiomer, the major component enantiomer can be further enriched (with concomitant loss in yield) by recrystallization.

When the compounds described herein contain olefinic double bonds or other centers of geometric asymmetry, and unless specified otherwise, it is intended that the compounds include both E and Z geometric isomers.

“Tautomer” refers to alternate forms of a molecule that differ only in electronic bonding of atoms and/or in the position of a proton, such as enol-keto and imine-enamine tautomers, or the tautomeric forms of heteroaryl groups containing a —N═C(H)—NH— ring atom arrangement, such as pyrazoles, imidazoles, benzimidazoles, triazoles, and tetrazoles. A person of ordinary skill in the art would recognize that other tautomeric ring atom arrangements are possible and contemplated herein.

Atropisomers are stereoisomers resulting from hindered rotation about single bonds where the barrier to rotation is high enough to allow for the isolation of the conformers. Atropisomerism is significant because it introduces an element of chirality in the absence of stereogenic atoms. The scope of the description is meant to encompass atropisomers, for example in cases of limited rotation about bonds between, for example, groups R¹ and/or R² on the N-heterocyclic carbene and the nitrogen which bears groups R¹ and/or R².

Similarly, it is understood that the above definitions are not intended to include impermissible substitution patterns (e.g., methyl substituted with 5 fluoro groups). Such impermissible substitution patterns are easily recognized by a person having ordinary skill in the art.

### Methods

Microwaves act as high frequency electric fields and will generally heat any material containing mobile electric charges, such as polar molecules in a solvent or conducting ions in a solid. Polar solvents are heated as their component molecules are forced to rotate with the field and lose energy in collisions. Conventional heating, for example using an oil bath or electrical resistance heating element, heats the walls of a reactor by convection or conduction. The core of the sample takes much longer to achieve the target temperature, e.g. when heating a large sample. Although microwave chemistry is known, since microwave heating works by different mechanisms that conventional heating, it is not readily predictable that a given chemical transformation will work with microwave heating. This unpredictability is due, in part, to the fact that different compounds convert microwave radiation to heat by different amounts. This heating selectivity means that some components of a reaction mixture will be heated more quickly or more slowly than others, this also includes the reaction vessel. Thus there can be drastic differential heating effects. The inventors were surprised to find that for making NHC-transition metal compounds as described herein, the reactions work efficiently and with high yields—at greatly enhanced reaction rates, depending on the compounds made. Thus the reaction rate is accelerated, the chemical yields were found to be comparable to those of conventional heating methods and there is less energy used.

For example, the conventional one-step synthesis of complexes 1 requires refluxing of NHC.HCl salts with palladium(II) acetylacetonate in dioxane (Scheme 1,

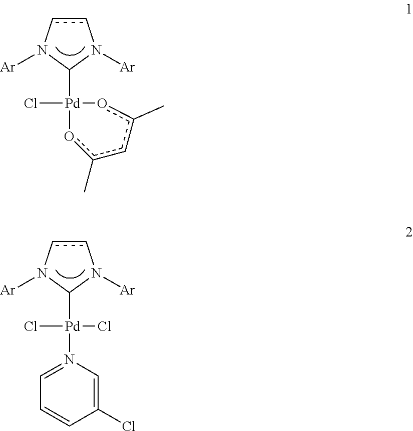

conditions a). The reaction time varies for the different NHC's, ranging between 14 h and 44 h. For instance, the synthesis of (IPr)Pd(acac)Cl (1b) (IPr=1,3-bis(2,6-diisopropyl-phenyl)-imidazol-2-ylidene) has been reported to be completed in 24 h under an inert atmosphere, while it requires 44 h to reach completion if conducted in aerobic conditions. These long reaction times are drastically reduced with the use of microwave heating: anaerobic, 0.5 mmol scale reactions were completed after 30 min at 110° C. in THF (Scheme 1, conditions b) and the products isolated in high yields (1a: 84%, 1b: 90%, 1c: 84%). It is noteworthy that this reaction time was not optimized. While these experiments were conveniently set up in a glovebox, the synthesis of 1b was also carried out loading the reactants in open air in a 5 mmol scale. This procedure afforded the product in 87% yield (2.76 g), also after 30 min of reaction time. So, the reaction times are the same, although the reaction scale was increased 10-fold with no detriment in the yield of product obtained. Also, if conventional heating is done in open air, for long periods of time in order to drive the reaction to completion, there is a serious risk of oxygen-induced degradation of the reactants (and/or products) and unwanted side reactions, which may lead to a significant drop off in the yield of the desired product.

A similar improvement was observed for the synthesis of complexes type 2, conventionally prepared by mixing NHC—HCl with palladium(II) chloride and potassium carbonate and heating in neat 3-chloropyridine (see Scheme 2). Employing conventional heating these reactions require 16 h of reaction time at 80° C., while high yields of the desired products (2a: 88%, 2b: 90%) were easily obtained after 45 min in the microwave reactor at 200° C. Microwave heating can be done in a sealed tube, or not, depending on the boiling point of any solvents used. Also, microwave heating is more energy efficient than conventional heating.

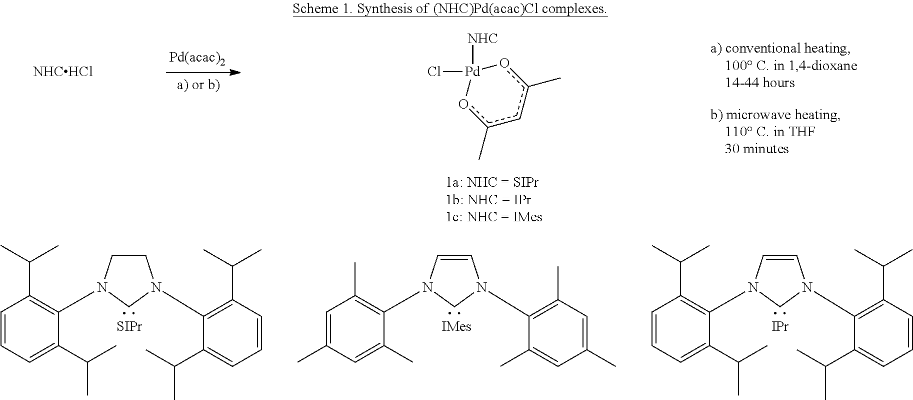

Thus, microwave-assisted synthesis of NHC-bearing palladium complexes allowed for a drastic reduction of the reaction times, 20 to 88 times faster in the above examples, for the synthesis of complexes type 1 and 2 and obtaining yields comparable to conventional heating procedures.

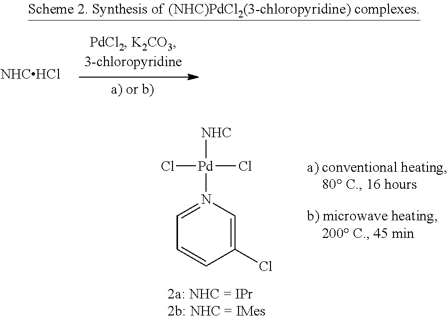

One embodiment is a method of making a compound of formula I,

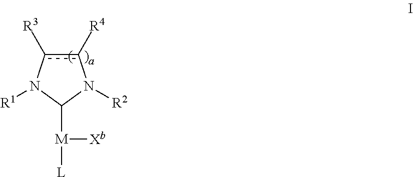

the method including:
(a) combining an N-heterocyclic carbene salt of formula II

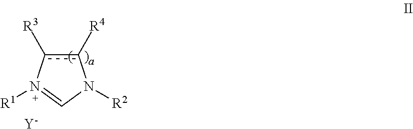

with either: i) a transition metal salt of formula MX_{b}, a ligand L and a base; or ii) a transition metal salt of formula L_{z}MX_{b}; and
(b) heating the mixture with microwave radiation;
   wherein:
each of R¹ and R² is independently H, C₁₋₂₀alkyl, C₃₋₂₀cycloalkyl, C₆₋₁₄aryl, C₇₋₁₆arylalkyl, 3-10 membered heteroalicyclyl, 4-11 membered heteroalicyclylalkyl, 5-15 membered heteroaryl or 6-16 membered heteroarylalkyl; each optionally substituted, and where any heteroatom of R¹ and R² is not bonded to the nitrogen which bears R¹ and R²;
R³ and R⁴ are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
R³ and one R⁴ group, taken together with the carbons to which they are attached, combine to form a 4-10 membered partially or fully saturated mono or bicyclic ring, optionally containing one or more heteroatoms and optionally substituted with one or more R^{a} and/or R^{b}, and remaining R⁴ groups, if any, are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{c} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
one of R³ and R⁴ is a bivalent linker that links the carbon bearing the R³ or R⁴ to a solid phase; and the remaining R³ or R⁴ groups, if any, are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆ arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙ—OR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁ cycloalkylalkyl, C₆₋₁₀aryl, C₇₋₁₆ arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3;
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
M is a transition metal;
b is an integer representing the number of monoanionic ligands X required to fulfill the valency requirements of M;
z is an integer representing the number of neutral mono-coordinating ligands L that M can accommodate along with monoanionic ligands X; when z is greater than 1, each L may be the same or different;
X is a monoanionic ligand; when b is greater than 1, each X may be the same or different;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; or R⁵⁵CH═CHR⁶⁵ wherein R⁵⁵ and R⁶⁵ are each independently H, C₁₋₂₀alkyl, C₃₋₂₀cycloalkyl, C₆₋₁₄aryl, C₇₋₁₆arylalkyl, 3-10 membered heteroalicyclyl, 4-11 membered heteroalicyclylalkyl or 5-15 membered heteroaryl or 6-16 membered heteroarylalkyl; each optionally substituted; or R⁵⁵ and R⁶⁵, together with the vinyl group to which they are attached, combine to form a 4 to 8 membered cycloalkyldiene;
in one or more instances, one of X can combine with one of L to form a bidentate monoanionic ligand, where said one of X is the anionic portion of the bidentate monoanionic ligand and L is the neutral coordination portion of the bidentate monoanionic ligand; and
Y is a suitable monoanion.

In instances where one of X combines with one of L to form a bidentate monoanionic ligand, such ligands include, for example, acetylacetonate and similar bidentate ligands described herein, but also, for example, ligands such as 2-phenylpyridines and the like, where complexes such as those illustrated below are formed, where the variables are as described herein.

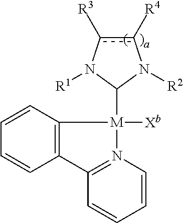

In some embodiments, the reaction is performed in a solvent. Organic solvents work well, including aprotic solvents such as ethers, for example, THF, 1,4-dioxane, glycol ethers, anisoles, dibutyl ether, and the like. Solvents with high dielectric loss values, for example ethers, heat rapidly when exposed to microwaves. In certain embodiments, the ligand, L, can act as the solvent. For example, in one embodiment, an optionally substituted pyridine is used as L. Many pyridines are liquids at room temperature. By using a stoichiometric excess of L, L can also serve as the solvent. Also, many pyridines or other N-heterocycles, although solids at room temperature, are liquids at higher temperatures, for example the reaction temperatures described herein, and thus can also serve as solvents.

In one embodiment, the N-heterocyclic carbene salt of formula II is combined with the transition metal salt of formula MX_{b}, a ligand L and a base; where M is Pd, Pt, Ni, Cu, Au, Ag, Ru, Rh or Ir; each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl; L is an optionally substituted 5-15 membered heteroaryl containing at least one nitrogen, oxygen or sulfur, said 5-15 membered coordinated to M through said at least one nitrogen, oxygen or sulfur; or one of X combines with one of L to form a bidentate monoanionic ligand, where said one of X is the anionic portion of the bidentate monoanionic ligand and L is the neutral coordination portion of the bidentate monoanionic ligand; and Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl.

In one embodiment, where the N-heterocyclic carbene salt of formula II is combined with the transition metal salt of formula MX_{b}, a ligand L and a base, a is 1; each of R¹ and R² is independently H, C₁₋₁₀alkyl, C₃₋₁₀cycloalkyl, C₆₋₁₀aryl or C₇₋₁₂arylalkyl; each optionally substituted; R³ and R⁴ are each independently H, R^{e} or R^{e} substituted with one or more of the same or different R^{a} and/or R^{b}; or R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b}; each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl; each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂; each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups; each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a}; each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl; each m is 1, 2 or 3; and each n is 0, 1, 2 or 3. In one embodiment, M is Pd, Ru, Rh or Cu. In another embodiment, M is Pd.

In another embodiment, where the N-heterocyclic carbene salt of formula II is combined with the transition metal salt of formula MX_{b}, a ligand L and a base, the base includes at least one of an alkali metal salt and an alkaline earth metal salt. In one embodiment, the base includes at least one of Cs₂CO₃, K₂CO₃, Na₂CO₃, K₃PO₄, CaCO₃ and NaOAc.

In another embodiment, where the N-heterocyclic carbene salt of formula II is combined with the transition metal salt of formula MX_{b}, a ligand L and a base, L is an optionally substituted 5-15 membered heteroaryl containing at least one nitrogen, oxygen or sulfur, said 5-15 membered coordinated to M through said at least one nitrogen, oxygen or sulfur. In one embodiment, L is a pyridine, quinoline, isoquinoline, pyrimidine, pyrazine, pyridazine, furan, benzofuran, isobenzofuran, thiophene, benzothiophene or benzo[c]thiophene, each optionally substituted. In one embodiment, L is an optionally substituted pyridine. In one embodiment, the optionally substituted pyridine is also the solvent. In one embodiment, L is 3-chloropyridine and may optionally serve as the solvent.

In another embodiment, where the N-heterocyclic carbene salt of formula II is combined with the transition metal salt of formula MX_{b}, a ligand L and a base, MX_{b} is a palladium dihalide salt. In one embodiment, MX_{b} is PdCl₂.

In another embodiment, where the N-heterocyclic carbene salt of formula II is combined with the transition metal salt of formula MX_{b}, a ligand L and a base, the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), slPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene). In one embodiment, the salt is an HCl salt.

In one embodiment, where the N-heterocyclic carbene salt of formula II is combined with the transition metal salt of formula MX_{b}, a ligand L and a base, the microwave heating is performed for between about 30 minutes and about 60 minutes, at between about 180° C. and about 220° C. In one embodiment, the microwave heating is performed for about 45 minutes, at about 200° C.

In one embodiment, the molar stoichiometry of the N-heterocyclic carbene salt of formula II to the PdCl₂ is between about 1:1 and about 1.2:1. In one embodiment, the base and the 3-chloropyridine are added in excess as compared to the N-heterocyclic carbene salt of formula II and the PdCl₂.

In one embodiment, where the N-heterocyclic carbene salt of formula II is combined with the transition metal salt of formula L_{z}MX_{b}, M is Pd, Pt, Ni, Cu, Au, Ag, Ru, Rh or Ir; each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl; in one or more instances, one of X combines with one of L to form a bidentate monoanionic ligand, where said one of X is the anionic portion of the bidentate monoanionic ligand and L is the neutral coordination portion of the bidentate monoanionic ligand; and Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl; In one embodiment, a is 1; each of R¹ and R² is independently H, C₁₋₁₀alkyl, C₃₋₁₀cycloalkyl, C₆₋₁₀aryl or C₇₋₁₂arylalkyl; each optionally substituted; R³ and R⁴ are each independently H, R^{e} or R^{e} substituted with one or more of the same or different R^{a} and/or R^{b}; or R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b}; each R^{a} is independently for each occurrence H, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl; each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂; each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups; each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a}; each R^{e} is independently for each occurrence C₁₋₆alkyl, C₃₋₈cycloalkyl, C₄₋₁₁ cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl; each m is 1, 2 or 3; and each n is 0, 1, 2 or 3. In one embodiment, M is Pd, Ru, Rh or Cu. In one embodiment, M is Pd.

In one embodiment, where the N-heterocyclic carbene salt of formula II is combined with the transition metal salt of formula L_{z}MX_{b}, the transition metal salt L_{z}MX_{b} is according to formula III:

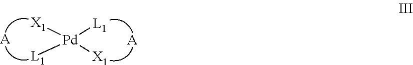

wherein:
each X₁ is the anionic portion of a bidentate monoanionic ligand X₁-A-L₁, and each L₁ is the neutral coordination portion of a bidentate monoanionic ligand X₁-A-L₁; and
X₁-A-L₁ is according to formula IV:

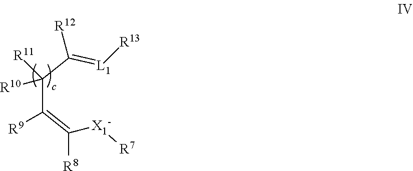

where each of X₁ and L₁ is independently O or N; R⁷, R⁸, R⁹, R¹⁰, R¹¹, R¹² and R¹³ are each independently H, C₁₋₆alkyl, C₃₋₈cycloalkyl, C₄₋₁₁ cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroaryl alkyl, each optionally substituted; provided R⁷ and R¹³ are present only when X₁ and/or L₁ are N; c is 0, 1 or 2; and the compound of formula I includes one of the bidentate monoanionic ligand X₁-A-L₁ and one monoanionic ligand X.

In one embodiment, for both formula III and formula VI, the bidentate monoanionic ligand X₁-A-L₁ is according to formula VII,

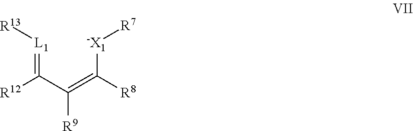

where each of X₁ and L₁ is independently O or N; R⁷, R⁸, R⁹, R¹² and R¹³ are each independently H, C₁₋₆alkyl, C₃₋₈ cycloalkyl, C₄₋₁₁ cycloalkylalkyl, C₆₋₁₀ aryl or C₇₋₁₆arylalkyl, each optionally substituted; provided R⁷ and R¹³ are present only when X₁ and/or L₁ are N; and the compound of formula I includes one of the bidentate monoanionic ligand X₁-A-L₁ and one monoanionic ligand X.

In one embodiment, X₁-A-L₁ is:

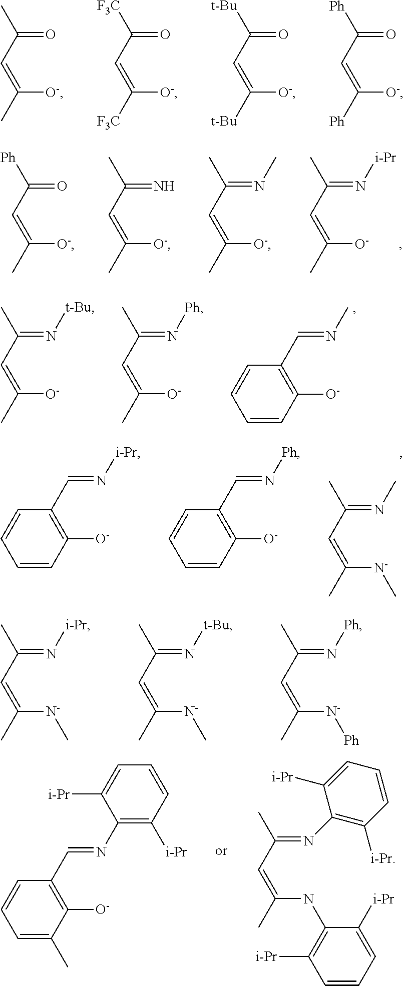

In another embodiment, X₁-A-L₁ is:

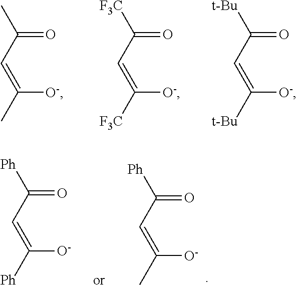

In another embodiment, X₁-A-L₁ is

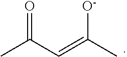

In one embodiment, where the N-heterocyclic carbene salt of formula II is combined with the transition metal salt of formula L_{z}MX_{b}, the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), sIPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene). The salt may be any suitable salt, but in one embodiment, it is the HCl salt.

In one embodiment, where the N-heterocyclic carbene salt of formula II is combined with the transition metal salt of formula L_{z}MX_{b}, the solvent includes an ether. In one embodiment, the solvent is THF. In one embodiment, the microwave heating is performed for between about 10 minutes and about 60 minutes, at between about 60° C. and about 120° C., in another embodiment, the microwave heating is performed for about 30 minutes, at about 110° C. In one embodiment, the molar stoichiometry of the N-heterocyclic carbene salt of formula II to the transition metal salt according to formula III is between about 1:1 and about 1.2:1.

Another aspect of the invention is a method of making a compound of formula I,

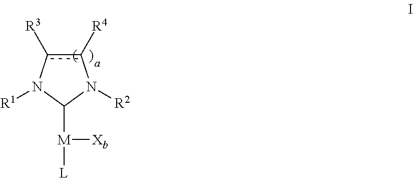

the method including:
(a) combining an N-heterocyclic carbene salt of formula II

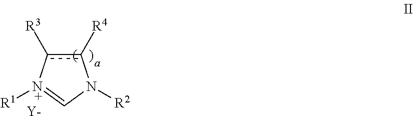

with a transition metal salt of formula MX_{b}, a ligand L and a base; and
(b) heating the mixture with microwave radiation;
   wherein:
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆ arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3; and
each n is 0, 1, 2 or 3.
M is Pd, Pt, Ni, Cu, Au, Ag, Ru, Rh or Ir;
b is an integer representing the number of monoanionic ligands X required to fulfill the valency requirements of M;
X is a monoanionic ligand;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; and
Y is a suitable anion.

In one embodiment, a is 1. In one embodiment, M is Pd, Ru, Rh or Cu. In another embodiment, M is Pd. In one embodiment, each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl. In one embodiment, Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl. In one embodiment, a solvent may be used in conjunction with the enumerated reagents. In one embodiment, the base includes at least one of an alkali metal salt and an alkaline earth metal salt. In one embodiment, the base includes at least one of Cs₂CO₃, K₂CO₃, Na₂CO₃, K₃PO₄, CaCO₃ and NaOAc. In one embodiment, L is a pyridine, quinoline, isoquinoline, pyrimidine, pyrazine, pyridazine, furan, benzofuran, isobenzofuran, thiophene, benzothiophene or benzo[c]thiophene, each optionally substituted; in another embodiment, L is an optionally substituted pyridine; in yet another embodiment, L is 3-chloropyridine. In one embodiment, the optionally substituted pyridine is also the solvent. In one embodiment, 3-chloropyridine is L and the solvent. In one embodiment, MX_{b} is PdCl₂. In one embodiment, the microwave heating is performed for between about 30 minutes and about 60 minutes, at between about 180° C. and about 220° C., in another embodiment, the microwave heating is performed for about 45 minutes, at about 200° C. In one embodiment, the molar stoichiometry of the N-heterocyclic carbene salt of formula II to the PdCl₂ is between about 1:1 and about 1.2:1. In one embodiment, the base and 3-chloropyridine are added in excess as compared to the N-heterocyclic carbene salt of formula II and the PdCl₂. The N-heterocyclic carbene salt is as described herein.

Another aspect of the invention is a method of making a compound of formula V,

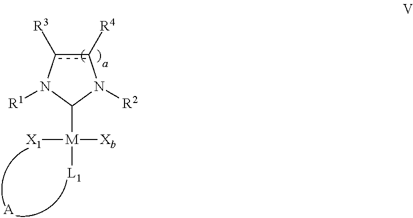

the method including:
(a) combining an N-heterocyclic carbene salt of formula II

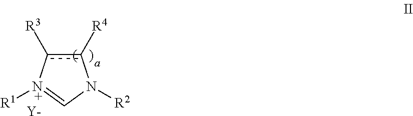

with a transition metal salt of formula VI; and

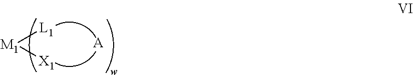

(b) heating the mixture with microwave radiation;
   wherein:
[symbol] is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3;
M₁ is Pd, Pt, Ni, Cu, Au, Ag, Ru, Rh or Ir; when M₁ is Ag, then w is 1; when M₁ is Pd, Pt, Ni or Cu, then w is 2; when M₁ is Ir, Au, Rh or Ru, then w is 3;
b is an integer representing the number of monoanionic ligands X required to fulfill the valency requirements of M;
X is a monoanionic ligand;
Y is a suitable anion; and
X₁-A-L₁ is according to formula IV:

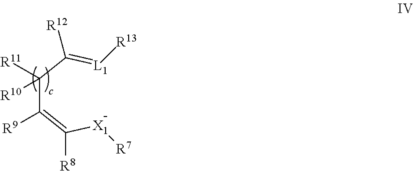

wherein each of X₁ and L₁ is independently O or N; R⁷, R⁸, R⁹, R¹⁰, R¹¹, R¹² and R¹³ are each independently H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroaryl alkyl, each optionally substituted; provided R⁷ and R¹³ are present only when X₁ and/or L₁ are N; c is 0, 1 or 2; and the compound of formula I includes one of the bidentate monoanionic ligand X₁-A-L₁ and one monoanionic ligand X.

In one embodiment, a is 1. In another embodiment, M₁ is Pd, Ru, Rh or Cu, in one embodiment, M₁ is Pd. In one embodiment, each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl. In The method of claim 56, wherein Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl. The reaction may or may not include a solvent as described herein, and X₁-A-L₁ is as described herein. The N-heterocyclic carbene salt of formula II is a salt as described herein. The solvent can include an ether, and in one embodiment, the solvent is THF. In one embodiment, the microwave heating is performed for between about 10 minutes and about 60 minutes, at between about 60° C. and about 120° C., in another embodiment, the microwave heating is performed for about 30 minutes, at about 110° C. In one embodiment, the molar stoichiometry of the N-heterocyclic carbene salt of formula II to the transition metal salt according to formula III is between about 1:1 and about 1.2:1.

### EXAMPLES

The invention is further understood by reference to the following examples, which are not intended to be limiting. Any synthetic methods that are functionally equivalent are within the scope of the invention. Various modifications of the embodiments described herein would be apparent to one of ordinary skill in the art from the foregoing description and accompanying figures. Such modifications fall within the scope of the appended claims.

All reactions were set up in oven-dried glassware in a nitrogen-filled MBraun Unilab glovebox unless otherwise noted. All reagents were obtained from commercial sources and used without further purification. 1,3-bis(2,6-diisopropylphenyl)-imida-zolinium chloride (SIPr.HCl), 1,3-bis(2,6-diisopropylphenyl)-imidazolium chloride (IPr.HCl) and 1,3-bis(2,4,6-trimethylphenyl)-imidazolium chloride (IMes.HCl) were prepared according to literature procedures (for example, see A. J. Arduengo III, R. Krafczyk, R. Schmutzler, Tetrahedron 1999, 55, 14523-14534, which is incorporated by reference herein for all purposes). Dry THF was dispensed from an MBraun solvent purification system. Microwave reactions were carried out in a CEM Discover unit (5 to 300 watts). NMR spectra were recorded on a Varian Mercury 300 MHz spectrometer and were referenced to tetramethylsilane.

### Example 1

### (NHC)Pd(acac)Cl Complexes

A microwave-vial was loaded with NHC.HCl (0.55 mmol), palladium(II) acetylacetonate (153 mg, 0.500 mmol), anhydrous THF (5 mL) and a magnetic bar. The mixture was heated in the microwave reactor for 30 min at 110° C. The solvent was removed in vacuo and the resulting product was dissolved in methylene chloride. This solution was filtered over a plug of silica gel and the silica gel was rinsed with methylene chloride. Removal of the solvent in vacuo afforded the desired products as yellow solids.

(SIPr)Pd(acac)Cl:

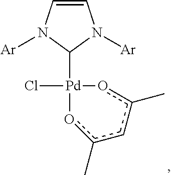

where Ar is:

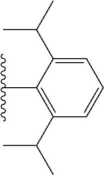 [SMILES: *c1c(C(C)C)cccc1C(C)C]

265 mg (84%) of the title compound were obtained using SIPr.HCl (235 mg, 0.550 mmol). ¹H NMR (300 MHz, CDCl₃): δ (ppm)=7.40 (t, ³J=7.7 Hz, 2H), 7.28 (broad d, ³J=8.0 Hz, 4H), 5.04 (s, 1H), 4.05 (s, 4H), 3.42 (broad s, 4H), 1.78 (s, 3H), 1.76 (s, 3H), 1.42 (broad s, 12H), 1.25 (d, ³J=6.8 Hz, 12H).

(IPr)Pd(acac)Cl:

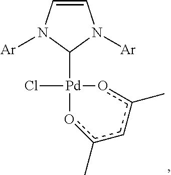

where Ar is:

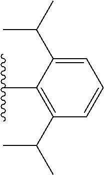 [SMILES: *c1c(C(C)C)cccc1C(C)C]

283 mg (90%) of the title compound were obtained using IPr.HCl (234 mg, 0.550 mmol). ¹H NMR (300 MHz, CDCl₃): δ (ppm)=7.50 (t, ³J=7.7 Hz, 2H), 7.34 (d, ³J=7.7 Hz, 4H), 7.11 (s, 2H), 5.11 (s, 1H), 2.94 (sept, ³J=6.7 Hz, 4H), 1.83 (s, 3H), 1.81 (s, 3H), 1.33 (d, ³J=6.5 Hz, 12H), 1.09 (d, ³J=6.8 Hz, 12H).

Large-Scale Synthesis of (IPr)Pd(acac)Cl: In open air, a microwave vial was charged with IPr.HCl (2.34 g, 5.50 mmol), palladium acetylacetonate (1.53 g, 5.00 mmol), anhydrous THF (20 mL) and a magnetic bar. The mixture was heated in the microwave reactor for 30 min at 110° C. 2.76 g (87%) of the title compound were obtained following the general work-up. The purity of the complex was confirmed by ¹H NMR.

(IMes)Pd(acac)Cl:

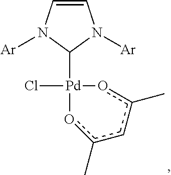

where Ar is:

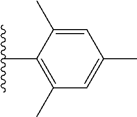 [SMILES: *c1c(C)cc(C)cc1C]

229 mg (84%) of the title compound were obtained using IMes.HCl (188 mg, 0.550 mmol). ¹H NMR (300 MHz, CDCl₃): δ (ppm)=7.06 (broad s, 2H), 7.01 (broad s, 4H), 5.12 (s, 1H), 2.37 (s, 6H), 2.31 (broad s, 6H), 2.14 (broad s, 6H), 1.82 (s, 3H), 1.77 (s, 3H).

### Example 2

### (NHC)PdCl₂(3-chloropyridine) Complexes

A microwave-vial was loaded with NHC.HCl (0.55 mmol), palladium(II) chloride (89 mg, 0.50 mmol), potassium carbonate (345 mg, 2.5 mmol), 3-chloropyridine (2 mL) and a magnetic bar. The mixture was heated in a microwave reactor for 45 min at 200° C. The mixture was diluted with methylene chloride, filtered over a plug of silica gel that was covered with celite and the silica gel was rinsed with methylene chloride. The solvent and excess chloropyridine were removed in vacuo, the product was triturated in pentane and the pentane was decanted. Drying in vacuo afforded the desired products as yellow solids.

(IPr)PdCl₂(3-chloropyridine):

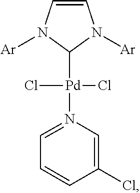

where Ar is:

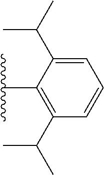 [SMILES: *c1c(C(C)C)cccc1C(C)C]

309 mg (88%) of the title compound were obtained using IPr.HCl (234 mg, 0.550 mmol). ¹H NMR (300 MHz, CDCl₃): δ (ppm)=8.60 (d, ³J=2.4 Hz, 1H), 8.52 (dd, ³J=5.5 Hz, ³J=1.3 Hz, 1H), 7.55 (ddd, ³J=8.2 Hz, ³J=2.3 Hz, ³J=1.3 Hz, 1H), 7.50 (t, ³J=7.8 Hz, 2H), 7.35 (d, ³J=7.7 Hz, 4H), 7.14 (s, 2H), 7.07 (dd, ³J=8.2 Hz, ³J=5.5 Hz), 3.16 (sept, ³J=6.7 Hz, 4H), 1.48 (d, ³J=6.6 Hz, 12H), 1.12 (d, ³J=6.9 Hz, 12H).

(IMes)PdCl₂(3-chloropyridine):

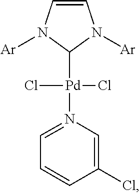

where Ar is:

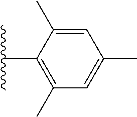 [SMILES: *c1c(C)cc(C)cc1C]

276 mg (90%) of the title compound were obtained using IMes.HCl (188 mg, 0.550 mmol). ¹H NMR (300 MHz, CDCl₃): δ (ppm)=8.60 (d, ³J=2.3 Hz, 1H), 8.50 (dd, ³J=5.4 Hz, ³J=1.3 Hz, 1H), 7.55 (ddd, ³J=8.2 Hz, ³J=2.2 Hz, ³J=1.3 Hz, 1H), 7.10-7.06 (m, 7H), 2.39 (s, 6H), 2.37 (s, 12H).

Although the foregoing invention has been described in some detail to facilitate understanding, the described embodiments are to be considered illustrative and not limiting. It will be apparent to one of ordinary skill in the art that certain changes and modifications can be practiced within the scope of the appended claims.

We claim:

1. A method of making a compound of formula I, 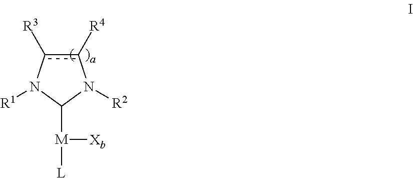
the method comprising:
(a) combining an N-heterocyclic carbene salt of formula II 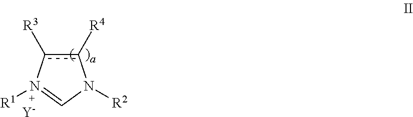
with either: i) a transition metal salt of formula MX_{b}, a ligand L and a base; or ii) a transition metal salt of formula L_{z}MX_{b}; and
(b) heating the mixture with microwave radiation;
wherein:
each of R¹ and R² is independently H, C₁₋₂₀alkyl, C₃₋₂₀cycloalkyl, C₆₋₁₄aryl, C₇₋₁₆arylalkyl, 3-10 membered heteroalicyclyl, 4-11 membered heteroalicyclylalkyl, 5-15 membered heteroaryl or 6-16 membered heteroarylalkyl; each optionally substituted, and where any heteroatom of R¹ and R² is not bonded to the nitrogen which bears R¹ and R²;
R³ and R⁴ are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
R³ and one R⁴ group, taken together with the carbons to which they are attached, combine to form a 4-10 membered partially or fully saturated mono or bicyclic ring, optionally containing one or more heteroatoms and optionally substituted with one or more R^{a} and/or R^{b}, and remaining R⁴ groups, if any, are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b}; or
one of R³ and R⁴ is a bivalent linker that links the carbon bearing the R³ or R⁴ to a solid phase; and the remaining R³ or R⁴ groups, if any, are each independently for each occurrence H, R^{e}, R^{b}, R^{e} substituted with one or more of the same or different R^{a} and/or R^{b}, —OR^{e} substituted with one or more of the same or different R^{a} and/or R^{b}, —C(O)R^{e} substituted with one or more of the same or different R^{a} and/or R^{b}, —N(R^{a})R^{e} where R^{e} is substituted with one or more of the same or different R^{a} and/or R^{b}, —S(O)₂R^{e} substituted with one or more of the same or different R^{a} and/or R^{b}, —N(R^{a})—S(O)₂R^{e} where R^{e} is substituted with one or more of the same or different R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3; [symbol]
is a single or a double bond;
a is 1, 2 or 3; when a is 3, either there is a single or a double bond between the second and third carbons bearing R⁴, or [symbol] is a single bond and there is a double bond between the first and second carbons bearing R⁴;
M is a transition metal;
b is an integer representing the number of monoanionic ligands X required to fulfill the valency requirements of M;
z is an integer representing the number of neutral mono-coordinating ligands L that M can accommodate along with monoanionic ligands X; when z is greater than 1, each L may be the same or different;
X is a monoanionic ligand; when b is greater than 1, each X may be the same or different;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; or R⁵⁵CH═CHR⁶⁵ wherein R⁵⁵ and R⁶⁵ are each independently H, C₁₋₂₀alkyl, C₃₋₂₀ cycloalkyl, C₆₋₁₄aryl, C₇₋₁₆arylalkyl, 3-10 membered heteroalicyclyl, 4-11 membered heteroalicyclylalkyl or 5-15 membered heteroaryl or 6-16 membered heteroarylalkyl; each optionally substituted; or R⁵⁵ and R⁶⁵, together with the vinyl group to which they are attached, combine to form a 4 to 8 membered cycloalkyldiene;
in one or more instances, one of X can combine with one of L to form a bidentate monoanionic ligand, where said one of X is the anionic portion of the bidentate monoanionic ligand and L is the neutral coordination portion of the bidentate monoanionic ligand; and
Y is a suitable monoanion.

2. The method of claim 1, wherein a) further comprises an organic solvent.

3. The method of claim 2, wherein the N-heterocyclic carbene salt of formula II is combined with the transition metal salt of formula MX_{b}, a ligand L and a base; wherein:
M is Pd, Pt, Ni, Cu, Au, Ag, Ru, Rh or Ir;
each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF₆⁻; where R⁵ is C₁₋₆alkyl or perfluoroC₁₋₆alkyl;
L is an optionally substituted 5-15 membered heteroaryl containing at least one nitrogen, oxygen or sulfur, said 5-15 membered coordinated to M through said at least one nitrogen, oxygen or sulfur; or
one of X combines with one of L to form a bidentate monoanionic ligand, where said one of X is the anionic portion of the bidentate monoanionic ligand and L is the neutral coordination portion of the bidentate monoanionic ligand; and
Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF₆⁻; where R⁵ is C₁₋₆alkyl or perfluoroC₁₋₆alkyl.

4. The method of claim 3, wherein:
a is 1;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3; and
each n is 0, 1, 2 or 3.

5. The method of claim 4, wherein M is Pd, Ru, Rh or Cu.

6. The method of claim 4, wherein M is Pd.

7. The method of claim 6, wherein the base comprises at least one of an alkali metal salt and an alkaline earth metal salt.

8. The method of claim 6, wherein the base includes at least one of Cs₂CO₃, K₂CO₃, Na₂CO₃, K₃PO₄, CaCO₃ and NaOAc.

9. The method of claim 6, wherein L is an optionally substituted 5-15 membered heteroaryl containing at least one nitrogen, oxygen or sulfur, said 5-15 membered coordinated to M through said at least one nitrogen, oxygen or sulfur.

10. The method of claim 6, wherein L is a pyridine, quinoline, isoquinoline, pyrimidine, pyrazine, pyridazine, furan, benzofuran, isobenzofuran, thiophene, benzothiophene or benzo[c]thiophene, each optionally substituted.

11. The method of claim 6, wherein L is an optionally substituted pyridine.

12. The method of claim 11, wherein the optionally substituted pyridine is also the organic solvent.

13. The method of claim 12, wherein MX_{b} is PdCl₂.

14. The method of claim 13, wherein the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), sIPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene).

15. The method of claim 14, wherein L is 3-chloropyridine.

16. The method of claim 15, wherein the microwave heating is performed for between about 30 minutes and about 60 minutes, at between about 180° C. and about 220° C.

17. The method of claim 15, wherein the microwave heating is performed for about 45 minutes, at about 200° C.

18. The method of claim 15, wherein the molar stoichiometry of the N-heterocyclic carbene salt of formula II to the PdCl₂ is between about 1:1 and about 1.2:1.

19. The method of claim 18, wherein the base and the 3-chloropyridine are added in excess as compared to the N-heterocyclic carbene salt of formula II and the PdCl₂.

20. The method of claim 2, wherein the N-heterocyclic carbene salt of formula II is combined with the transition metal salt of formula L_{z}MX_{b}; wherein:
M is Pd, Pt, Ni, Cu, Au, Ag, Ru, Rh or Ir;
each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF₆⁻; where R⁵ is C₁₋₆alkyl or perfluoroC₁₋₆alkyl;
in one or more instances, one of X combines with one of L to form a bidentate monoanionic ligand, where said one of X is the anionic portion of the bidentate monoanionic ligand and L is the neutral coordination portion of the bidentate monoanionic ligand; and
Y is F⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF₆⁻; where R⁵ is C₁₋₆alkyl or perfluoroC₁₋₆alkyl.

21. The method of claim 20, wherein:
a is 1;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{c} or R^{c} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁ cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3; and
each n is 0, 1, 2 or 3.

22. The method of claim 21, wherein M is Pd, Ru, Rh or Cu.

23. The method of claim 21, wherein M is Pd.

24. The method of claim 23, wherein the transition metal salt L_{z}MX_{b} is according to formula III: 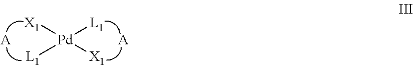
wherein:
each X₁ is the anionic portion of a bidentate monoanionic ligand X₁-A-L₁, and each L₁ is the neutral coordination portion of a bidentate monoanionic ligand X₁-A-L₁; and
X₁-A-L₁ is according to formula IV: 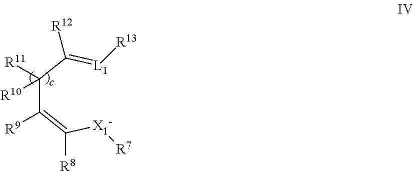
wherein each of X₁ and L₁ is independently O or N; R⁷, R⁸, R⁹, R¹⁰, R¹¹, R¹² and R¹³ are each independently H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl, each optionally substituted; provided R⁷ and R¹³ are present only when X₁ and/or L₁ are N; c is 0, 1 or 2; and the compound of formula I comprises one of the bidentate monoanionic ligand X₁-A-L₁ and one monoanionic ligand X.

25. The method of claim 24, wherein X₁-A-L₁ is:

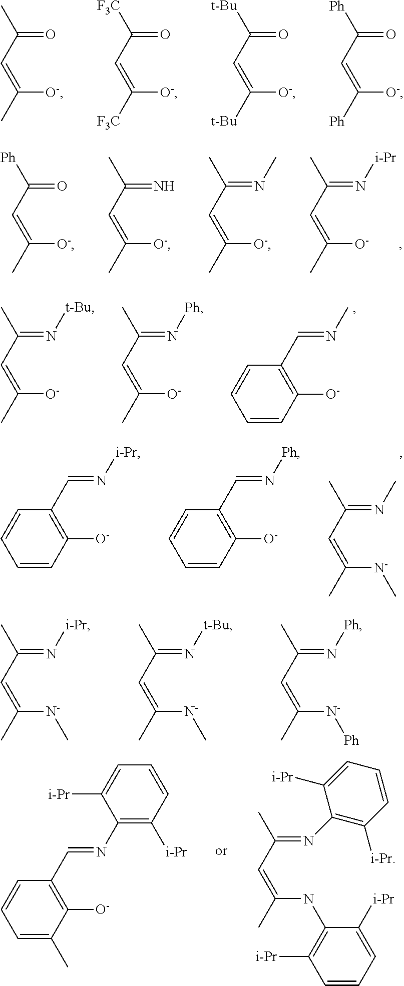

26. The method of claim 24, wherein X₁-A-L₁ is:

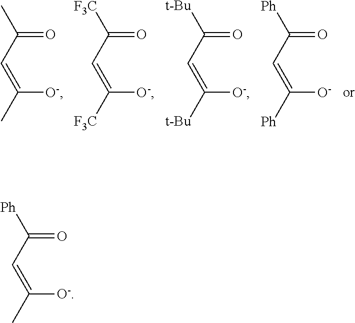

27. The method of claim 24, wherein X₁-A-L₁ is

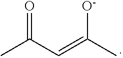

28. The method of claim 26, wherein the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), sIPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene).

29. The method of claim 28, wherein the solvent comprises an ether.

30. The method of claim 28, wherein the solvent is THF.

31. The method of claim 30, wherein the microwave heating is performed for between about 10 minutes and about 60 minutes, at between about 60° C. and about 120° C.

32. The method of claim 30, wherein the microwave heating is performed for about 30 minutes, at about 110° C.

33. The method of claim 30, wherein the molar stoichiometry of the N-heterocyclic carbene salt of formula II to the transition metal salt according to formula III is between about 1:1 and about 1.2:1.

34. A method of making a compound of formula I, 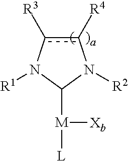
the method comprising:
(a) combining an N-heterocyclic carbene salt of formula II 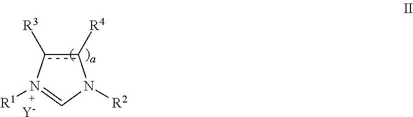
with a transition metal salt of formula MX_{b}, a ligand L and a base; and
(b) heating the mixture with microwave radiation;
wherein: [symbol]
is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3; and
each n is 0, 1, 2 or 3.
M is Pd, Pt, Ni, Cu, Au, Ag, Ru, Rh or Ir;
b is an integer representing the number of monoanionic ligands X required to fulfill the valency requirements of M;
X is a monoanionic ligand;
each L is, independently, an optionally substituted 5-15 membered heteroaryl containing at least one nitrogen, oxygen or sulfur, said optionally substituted 5-15 membered heteroaryl coordinated to M through said at least one nitrogen, oxygen or sulfur; and
Y is a suitable anion.

35. The method of claim 34, wherein a is 1.

36. The method of claim 35, wherein M is Pd, Ru, Rh or Cu.

37. The method of claim 35, wherein M is Pd.

38. The method of claim 37, wherein each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl.

39. The method of claim 37, wherein Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl.

40. The method of claim 38, wherein a) further comprises an organic solvent.

41. The method of claim 39, wherein the base comprises at least one of an alkali metal salt and an alkaline earth metal salt.

42. The method of claim 39, wherein the base includes at least one of Cs₂CO₃, K₂CO₃, Na₂CO₃, K₃PO₄, CaCO₃ and NaOAc.

43. The method of claim 41, wherein L is a pyridine, quinoline, isoquinoline, pyrimidine, pyrazine, pyridazine, furan, benzofuran, isobenzofuran, thiophene, benzothiophene or benzo[c]thiophene, each optionally substituted.

44. The method of claim 41, wherein L is an optionally substituted pyridine.

45. The method of claim 44, wherein the optionally substituted pyridine is also the organic solvent.

46. The method of claim 45, wherein L is 3-chloropyridine.

47. The method of claim 46, wherein MX_{b} is PdCl₂.

48. The method of claim 47, wherein the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), sIPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene).

49. The method of claim 48, wherein the microwave heating is performed for between about 30 minutes and about 60 minutes, at between about 180° C. and about 220° C.

50. The method of claim 48, wherein the microwave heating is performed for about 45 minutes, at about 200° C.

51. The method of claim 48, wherein the molar stoichiometry of the N-heterocyclic carbene salt of formula II to the PdCl₂ is between about 1:1 and about 1.2:1.

52. The method of claim 51, wherein the base and the 3-chloropyridine are added in excess as compared to the N-heterocyclic carbene salt of formula II and the PdCl₂.

53. A method of making a compound of formula V, 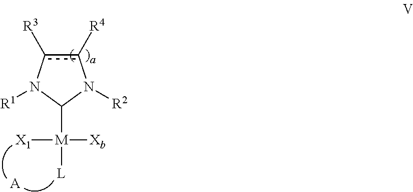
the method comprising:
(a) combining an N-heterocyclic carbene salt of formula II 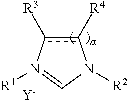
with a transition metal salt of formula VI; and 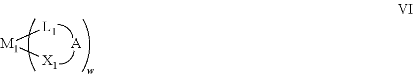
(b) heating the mixture with microwave radiation;
wherein: [symbol]
is a single or a double bond;
a is 1, 2 or 3; when a is 3, either there is a single or a double bond between the second and third carbons bearing R⁴, or [symbol] is a single bond and there is a double bond between the first and second carbons bearing R⁴;
each of R¹ and R² is independently H, C₁₋₁₀alkyl, C₃₋₁₀cycloalkyl, C₆₋₁₀aryl or C₇₋₁₂arylalkyl; each optionally substituted;
R³ and R⁴ are each independently H, R^{e} or R^{e} substituted with one or more of the same or different R^{a} and/or R^{b}; or
R³ and R⁴, taken together with the carbons to which they are attached, combine to form a 4-10 membered partially or fully saturated mono or bicyclic ring, optionally containing one or more heteroatoms and optionally substituted with one or more R^{a} and/or R^{b};
each R^{a} is independently for each occurrence H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each R^{b} is independently for each occurrence ═O, —OR^{a}, —O—(C(R^{a})₂)ₘ—OR^{a}, —N(R^{c})₂, haloC₁₋₃alkyloxy, halo, —CF₃, —CN, —NO₂, —S(O)₂R^{a}, —SO₃R^{a}, —S(O)N(R^{c})₂, —S(O)₂N(R^{c})₂, —C(O)R^{a}, —CO₂R^{a} or —C(O)N(R^{c})₂;
each R^{c} is independently for each occurence R^{a}, or, alternatively, two R^{c} are taken together with the nitrogen atom to which they are bonded to form a 3 to 10-membered heteroalicyclyl or a 5-10 membered heteroaryl which may optionally include one or more of the same or different additional heteroatoms and which is optionally substituted with one or more of the same or different R^{a} and/or R^{d} groups;
each R^{d} is ═O, —OR^{a}, haloC₁₋₃alkyloxy, C₁₋₆alkyl, —N(R^{a})₂, halo, —CF₃, —CN, —NO₂, —S(O₂)R^{a}, —SO₃R^{a}, —C(O)R^{a}, —CO₂R^{a}, —C(O)N(R^{a})₂, —C(O)—C₁₋₆haloalkyl, —S(O)₂C₁₋₆haloalkyl, —OC(O)R^{a}, —O(C(R^{a})₂)ₘ—OR^{a}, —N(R^{a})C₁₋₆haloalkyl, —P(O)(OR^{a})₂, —N(R^{a})—(C(R^{a})₂)ₘ—OR^{a}, —[N(R^{a})C(O)]ₙOR^{a}, —[N(R^{a})C(O)]ₙN(R^{a})₂, or —N(R^{a})C(O)C₁₋₆haloalkyl; two R^{d}, taken together with the atom or atoms to which they are attached, combine to form a 3-10 membered partially or fully saturated mono or bicyclic ring, optionally containing one or more heteroatoms and optionally substituted with one or more R^{a};
each R^{e} is independently for each occurrence C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl;
each m is 1, 2 or 3;
each n is 0, 1, 2 or 3;
M₁ is Pd, Pt, Ni, Cu, Au, Ag, Ru, Rh or Ir; when M₁ is Ag, then w is 1; when M₁ is Pd, Pt, Ni or Cu, then w is 2; when M₁ is Ir, Au, Rh or Ru, then w is 3;
b is an integer representing the number of monoanionic ligands X required to fulfill the valency requirements of M;
X is a monoanionic ligand;
Y is a suitable anion; and
X₁-A-L₁ is according to formula IV: 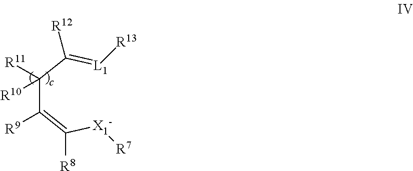
wherein each of X₁ and L₁ is independently O or N; R⁷, R⁸, R⁹, R¹⁰, R¹¹, R¹² and R¹³ are each independently H, C₁₋₆alkyl, C₃₋₈cycloalkyl, C₄₋₁₁cycloalkylalkyl, C₆₋₁₀aryl, C₇₋₁₆arylalkyl, 2-6 membered heteroalkyl, 3-10 membered heteroalicyclyl, 4-11 membered heteroalicyclylalkyl, 5-15 membered heteroaryl or 6-16 membered heteroarylalkyl, each optionally substituted; provided R⁷ and R¹³ are present only when X₁ and/or L₁ are N; c is 0, 1 or 2; and the compound of formula I comprises one of the bidentate monoanionic ligand X₁-A-L₁ and one monoanionic ligand X.

54. The method of claim 53, wherein a is 1.

55. The method of claim 53, wherein M₁ is Pd, Ru, Rh or Cu.

56. The method of claim 54, wherein M₁ is Pd.

57. The method of claim 56, wherein each X is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl.

58. The method of claim 56, wherein Y is F⁻, Cl⁻, Br⁻, I⁻, ⁻OC(O)R⁵, ⁻O(SO₂)R⁵, ⁻O(SO₂)Ph-R⁵, BF₄⁻, ⁻B(F₅C₆)₄ or PF6⁻; where R⁵ is C₁₋₆alkyl or perfluoroC₁₋₆alkyl.

59. The method of claim 57, wherein a) further includes an organic solvent.

60. The method of claim 59, wherein X₁-A-L₁ is:

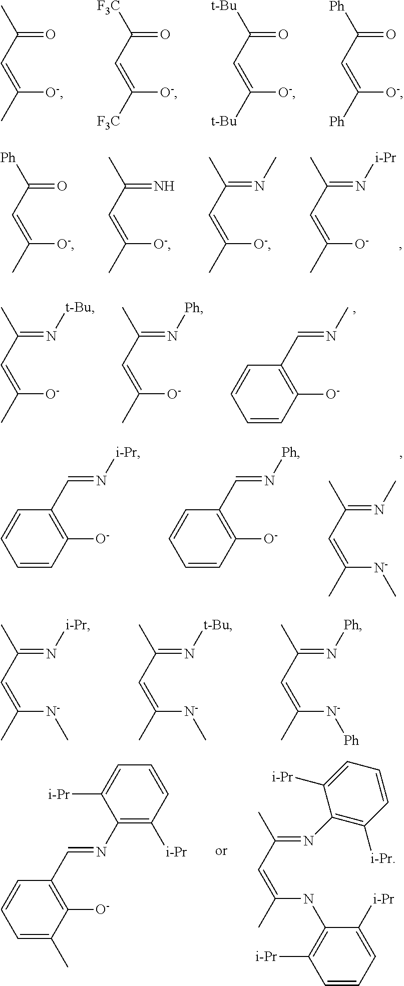

61. The method of claim 59, wherein X₁-A-L₁ is:

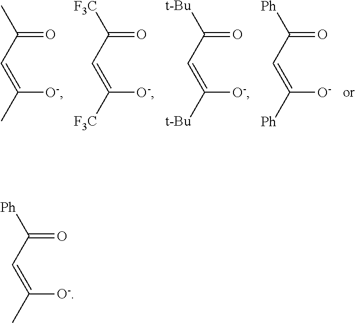

62. The method of claim 59, wherein X₁-A-L₁ is

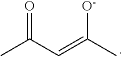

63. The method of claim 61, wherein the N-heterocyclic carbene salt of formula II is a salt of IMes (N,N′-bis(2,4,6-trimethylphenyl)imidazol)-2-ylidene), sIMes (N,N′-bis(2,4,6-trethylphenyl)-4,5-dihydroimidazol)-2-ylidene), IPr (N,N′-bis(2,6-diisopropylphenyl)imidazol)-2-ylidene), sIPr (N,N′-bis(2,6-diisopropylphenyl)-4,5-dihydroimidazol)-2-ylidene), IAd (N,N′-bis(adamantyl)imidazol-2-ylidene), ICy (N,N′-bis(cyclohexyl)imidazol-2-ylidene) or ItBu (N,N′-bis(tert-butyl)imidazol-2-ylidene).

64. The method of claim 63, wherein the solvent comprises an ether.

65. The method of claim 63, wherein the solvent is THF.

66. The method of claim 65, wherein the microwave heating is performed for between about 10 minutes and about 60 minutes, at between about 60° C. and about 120° C.

67. The method of claim 65, wherein the microwave heating is performed for about 30 minutes, at about 110° C.

68. The method of claim 65, wherein the molar stoichiometry of the N-heterocyclic carbene salt of formula II to the transition metal salt according to formula III is between about 1:1 and about 1.2:1.
